(19) United States
(12) Patent Application Publication
(10) Pub. No.: US 2026/0246513 A1
(43) Pub. Date: Aug. 20, 2026

(54) DEVICE AND METHOD FOR OPTIMIZING INDEX CODING AND BEAMFORMING BETWEEN WIRELESS DEVICES

(71) Applicant: SEOUL NATIONAL UNIVERSITY R&DB FOUNDATION, Seoul (KR)

(72) Inventor: Wan CHOI, Seoul (KR)

(21) Appl. No.: 19/647,984

(22) Filed: Apr. 15, 2026

Related U.S. Application Data
(63) Continuation of application No. PCT/KR2025/006423, filed on May 13, 2025.

(30) Foreign Application Priority Data
Nov. 29, 2024 (KR) 10-2024-0174366

(51) Int. Cl. H04B 7/06

(52) U.S. Cl. CPC H04B 7/0617

(57) ABSTRACT

A computing apparatus for performing index coding and beamforming optimization between wireless devices according to an embodiment comprises a memory in which an optimization program is stored and a processor configured to execute the optimization program, wherein the optimization program inputs state information of wireless devices to a reinforcement learning model to determine an index coding action and a beamforming design action that minimize transmission time between the wireless devices. The reinforcement learning model comprises a first-level agent configured to determine, as the index coding action, whether each wireless device performs index coding and a type of an index coding scheme to be used for index coding, and a second-level agent configured to determine, as the beamforming design action, an optimal beamformer design for each wireless device in consideration of the index coding action determined by the first-level agent.

### CROSS-REFERENCE TO RELATED APPLICATION

This application is a continuation application of International Application No. PCT/KR2025/006423, filed on May 13, 2025, which claims priority to Korean Patent Application No. 10-2024-0174366, filed on Nov. 29, 2024, in the Korean Intellectual Property Office, the disclosures of which are incorporated herein by reference in their entireties.

### BACKGROUND

### Technical Field

The present invention relates to an apparatus and a method for index coding and beamforming optimization between wireless devices.

### Background Art

Wireless data traffic has increased explosively in recent years due to text messaging, voice messaging, and video streaming. This increasing trend is expected to be further intensified by services such as virtual reality, augmented reality, and holograms. Although wireless data traffic has unique characteristics such as preferences for popular content and predictable demand, current wireless communication systems have improved efficiency by utilizing additional wireless communication resources without reflecting these unique characteristics. However, methods of utilizing wireless communication resources have reached a certain limit, and new technologies are required.

For these reasons, in a 5G wireless communication system, as one of new technologies, a caching technique has emerged in which users of a network store some data in memory. The caching technique is known to significantly reduce overall network traffic. According to a general caching technique, when user terminals request the same data, data transmission in a multicast manner is provided, and when users request different data, data transmission in a unicast manner is provided.

In order to process multicast data transmission for users requesting different data, an index coding technique has been utilized. The index coding technique refers to a coding technique that satisfies all requests of multiple users with a minimum number of transmissions by transmitting a result obtained by XORing two different bit streams. When a single central server possesses all requested file libraries, the problem is defined as an index coding problem, and research has been extended to a device-to-device index coding problem, which is a problem of finding an index coding technique between devices having a limited file library. Existing studies mainly address index coding in a wired environment, and when extended to a wireless multi-antenna system, spatial multiplexing gain can be obtained to achieve a greater gain in actual transmission time.

In consideration of the above, the present invention proposes an index coding technique between wireless devices having multiple antennas that minimizes transmission time based on a reinforcement learning technique in order to alleviate the high complexity of existing optimization techniques.

### PRIOR ART DOCUMENT

Korean Patent Application Publication No. 10-2024-0049112 (Title of Invention: Method and Apparatus for Transmitting Channel State Information).

### SUMMARY

The present invention addresses the above-described problems, and an object thereof is to provide an apparatus and a method for performing index coding and beamforming optimization between wireless devices by using a reinforcement learning model.

The technical object pursued by the present embodiment is not limited to the above-described technical object, and other technical objects may exist.

As a technical means for solving the above-described technical object, according to a first aspect of the present invention, a computing apparatus for performing index coding and beamforming optimization between wireless devices comprises a memory in which an optimization program is stored and a processor configured to execute the optimization program, wherein the optimization program inputs state information of wireless devices to a reinforcement learning model to determine an index coding action and a beamforming design action that minimize transmission time between the wireless devices. The reinforcement learning model comprises a first-level agent configured to determine, as the index coding action, whether each wireless device performs index coding and a type of an index coding scheme to be used for index coding, and a second-level agent configured to determine, as the beamforming design action, an optimal beamformer design for each wireless device in consideration of the index coding action determined by the first-level agent.

According to a second aspect of the present invention, a method for performing index coding and beamforming optimization between wireless devices, performed by a computing apparatus, comprises receiving state information of each wireless device, and inputting the state information of each wireless device to a reinforcement learning model to determine an index coding action and a beamforming design action that minimize transmission time between the wireless devices, wherein the reinforcement learning model comprises the first-level agent and the second-level agent as described above.

According to the above-described means for solving the problem, it is confirmed that, by applying reinforcement learning, an optimization action is determined faster and more accurately compared to conventional optimization techniques.

### BRIEF DESCRIPTION OF THE DRAWINGS

FIG. 1 is a diagram illustrating a wireless communication system to which the present invention is applied.

FIG. 2 is a diagram illustrating a detailed configuration of a computing apparatus according to an embodiment of the present invention.

FIG. 3 is a diagram illustrating a specific configuration of a reinforcement learning model according to an embodiment of the present invention.

FIG. 4 is a flowchart illustrating a method for index coding and beamforming optimization between wireless devices of a computing apparatus according to an embodiment of the present invention.

### DETAILED DESCRIPTION

Hereinafter, the present invention will be described in detail with reference to the accompanying drawings. However, the present invention may be implemented in various different forms and is not limited to the embodiments described herein. In addition, the accompanying drawings are provided only to facilitate an easy understanding of the embodiments disclosed in the present specification, and the technical spirit disclosed in the present specification is not limited by the accompanying drawings. In order to clearly describe the present invention, portions irrelevant to the description are omitted from the drawings, and the size, shape, and form of each component illustrated in the drawings may be variously modified. Throughout the specification, identical or similar reference numerals are assigned to identical or similar parts.

In the following description, suffixes such as “module” and “unit” used for components are assigned or used interchangeably only for convenience of description, and do not themselves have distinct meanings or roles. In addition, in describing the embodiments disclosed in the present specification, detailed descriptions of related well-known technologies are omitted when it is determined that such descriptions may obscure the gist of the embodiments disclosed herein.

Throughout the specification, when a certain part is described as being “connected (coupled, contacted, or joined)” to another part, this includes not only cases in which the part is “directly connected (coupled, contacted, or joined)” to another part, but also cases in which the part is “indirectly connected (coupled, contacted, or joined)” to another part with another member interposed therebetween. In addition, when a certain part is described as “including (comprising or provided with)” a certain component, this means that other components may be further “included (comprised or provided)” unless otherwise explicitly stated.

In the present specification, terms indicating ordinal numbers, such as first and second, are used only for the purpose of distinguishing one component from another and do not limit the order or relationship of the components. For example, a first component of the present invention may be referred to as a second component, and similarly, a second component may be referred to as a first component.

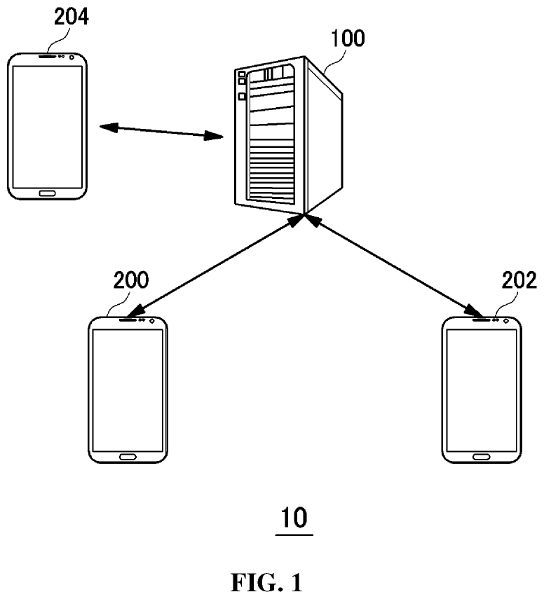

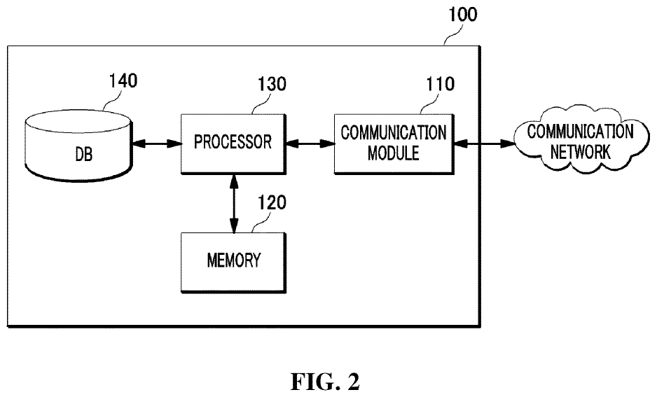

Referring to FIG. 1 and FIG. 2, FIG. 1 is a diagram illustrating a wireless communication system to which the present invention is applied, and FIG. 2 is a diagram illustrating a detailed configuration of a computing apparatus according to an embodiment of the present invention.

The wireless communication system (10) comprises a plurality of user terminals (200 to 204) capable of wireless communication, and a computing apparatus (100) configured to perform index coding and beamforming optimization between the user terminals.

Each of the user terminals (200 to 204) is a wireless communication device that ensures portability and mobility, and may include all types of handheld-based wireless communication devices such as smartphones, tablet PCs, and smart watches. In addition, each of the user terminals (200 to 204) is a device capable of communicating through a wireless data communication network, and supports communication such as 5G, 3GPP (3rd Generation Partnership Project), LTE (Long Term Evolution), WIMAX (World Interoperability for Microwave Access), and Wi-Fi. In particular, each of the user terminals (200 to 204) supports at least one index coding scheme and beamforming design.

The computing apparatus (100) determines an index coding action and a beamforming design action that minimize transmission time between wireless devices by using a reinforcement learning model in an environment including the plurality of user terminals (200 to 204). The computing apparatus (100) may be configured in the form of a server, and may operate in a cloud computing service model such as SaaS (Software as a Service), PaaS (Platform as a Service), or IaaS (Infrastructure as a Service).

The computing apparatus (100) comprises a memory (120) and a processor (130), and may further comprise a communication module (110) and a database (140).

The computing apparatus (100) is capable of wireless communication with each of the user terminals (200 to 204), and may be implemented as a computer or a portable terminal capable of accessing another computing apparatus through a network. The network refers to a connection structure capable of exchanging information between nodes such as terminals and devices, and includes a local area network (LAN), a wide area network (WAN), the Internet (WWW), a wired and wireless data communication network, a telephone network, and a wired and wireless television communication network. Examples of the wireless data communication network include, but are not limited to, 3G, 4G, 5G, 3GPP (3rd Generation Partnership Project), LTE (Long Term Evolution), WIMAX (World Interoperability for Microwave Access), Wi-Fi, Bluetooth communication, infrared communication, ultrasonic communication, visible light communication (VLC), and LiFi.

The communication module (110) may include a device including hardware and software required to transmit and receive signals such as control signals or data signals through wired or wireless connections with other network devices.

The memory (120) stores an optimization program, and the optimization program inputs state information of wireless devices to a reinforcement learning model to determine an index coding action and a beamforming design action that minimize transmission time between the wireless devices. In this case, the reinforcement learning model comprises a first-level agent configured to determine, as the index coding action, whether each wireless device performs index coding and a type of an index coding scheme to be used for index coding, and a second-level agent configured to determine, as the beamforming design action, an optimal beamformer design for each wireless device in consideration of the index coding action determined by the first-level agent.

The memory (120) should be interpreted as encompassing both a non-volatile storage device that retains stored information even when power is not supplied and a volatile storage device that requires power to retain stored information. The memory (120) may perform a function of temporarily or permanently storing data processed by the processor (130). The memory (120) may include, in addition to volatile storage devices requiring power to retain stored information, magnetic storage media or flash storage media, but the scope of the present invention is not limited thereto.

The processor (130) executes the optimization program stored in the memory (120), and transmits, as a result of the execution, the index coding action and the beamforming design action of each wireless device to the corresponding wireless devices.

In one embodiment, the processor (130) may be implemented in the form of a microprocessor, a central processing unit (CPU), a processor core, a multiprocessor, an application-specific integrated circuit (ASIC), a field programmable gate array (FPGA), or the like, but the scope of the present invention is not limited thereto.

The database (140) manages state information of each wireless device included in the system. In addition, the database (140) manages various programs and data required for execution of the optimization program. In particular, the database (140) manages training data for training the reinforcement learning model, and information on the index coding action and the beamforming design action of each wireless device inferred by the reinforcement learning model.

The system (10) of the present invention may be described as follows. The system (10) includes a total of K user terminals (200 to 204) capable of wireless communication, and each user terminal has K−1 antennas. In addition, each user terminal stores a portion of an entire file library in a cache, and a situation is assumed in which each user terminal requests a file that is not stored in its cache. Here, each file in the file library is stored in a cache of at least one user terminal. Transmission of the files requested by the user terminals is performed through data transmission between the user terminals, and in order to reduce transmission time, an index coding technique and a multicast beamforming technique are used for transmission.

In this case, a half-duplex transmission scheme is assumed, which refers to a transmission scheme in which reception is not performed during transmission and transmission is not performed during reception. In other words, each user terminal performs a role as a transmitting node and a receiving node, and two or more devices cannot be transmitting nodes at the same time. Accordingly, a signal (y) received by a k-th user terminal in a t-th communication round (a round in which the t-th user terminal performs transmission) may be expressed as follows.

$${y}_{k} [ t ] = {H}_{k}^{†} [ t ] x [ t ] + {z}_{k} [ t ] , \qquad [ Mathematical Expression 1 ]$$

Here, x denotes a transmission signal, H denotes a channel gain, and z denotes noise. When a set of coded messages transmitted by a t-th user terminal is denoted [symbol] , and an index set of the coded messages is denoted by [symbol] , the transmission signal (x) may be expressed as follows.

$$x [ t ] \hat{=} {\sum }_{i ∈ {ℐ}_{t}} {v}_{i} {m}_{i} , \qquad [ Mathematical Expression 2 ]$$

v denotes a transmit beamforming vector, and m denotes requested data. Each user terminal has a transmission power of P. When c(k) denotes an index of a message including data requested by a k-th user terminal, the received signal of Mathematical Expression 1 may be divided and expressed as a desired signal and an interference signal as shown in Mathematical Expression 3.

$$[ Mathematical Expression 3 ]$$

$${y}_{k} [ t ] = {H}_{k}^{†} [ t ] {v}_{C ( k )} {m}_{C ( k )} + {H}_{k}^{†} [ t ] ( {\sum }_{i ∈ {ℐ}_{t} \backslash \{ C ( k ) \}} {v}_{i} {m}_{i} ) + {z}_{k} [ t ] .$$

Accordingly, a signal-to-interference-and-noise ratio (SINR) may be expressed as follows.

$$SIN {R}_{Lk} ( {v}_{{ℐ}_{t}} ) \hat{=} \frac{{‖ {H}_{k}^{†} [ t ] {v}_{C ( k )} ‖}^{2}}{{\sum }_{i ∈ {ℐ}_{t} \backslash \{ C ( k ) \}} {‖ {H}_{k}^{†} [ t ] {v}_{i} ‖}^{2} + 1} , \qquad [ Mathematical Expression 4 ]$$

Here, B denotes a file size and W denotes a bandwidth. The present invention aims to optimize an index coding scheme [symbol] and a beamformer [symbol] that minimize a transmission time of all communication rounds defined in Mathematical Expression 5.

In the present invention, since a half-duplex transmission situation is assumed, once the index coding scheme is determined, the problem may be transformed, for each transmission round, into a multicast beamforming problem of finding an optimal beamformer. An optimization problem representing this is expressed as follows.

$$\begin{matrix}{maximize}_{{v}_{{ℐ}_{t}}} & {min}_{k ∈ {𝒟}_{t}} SIN {R}_{tk} ( {v}_{{ℐ}_{t}} ) \\ subject to & {\sum }_{i ∈ {ℐ}_{t}} {‖ {v}_{i} ‖}^{2} \leq P , for all t ∈ [ 1 : K ]\end{matrix} \qquad [ Mathematical Expression 6 ]$$

When an index coding scheme is given first, beamformer design must subsequently be performed in a dependent manner, and since index coding and beamforming correspond to actions in a discrete action space and a continuous action space, respectively, there exists a drawback in that they are difficult to design using a conventional reinforcement learning algorithm. Accordingly, in the present invention, two different agents are designed to have a hierarchical structure within a single environment, such that learning is performed with the goal of convergence of the reinforcement learning algorithm.

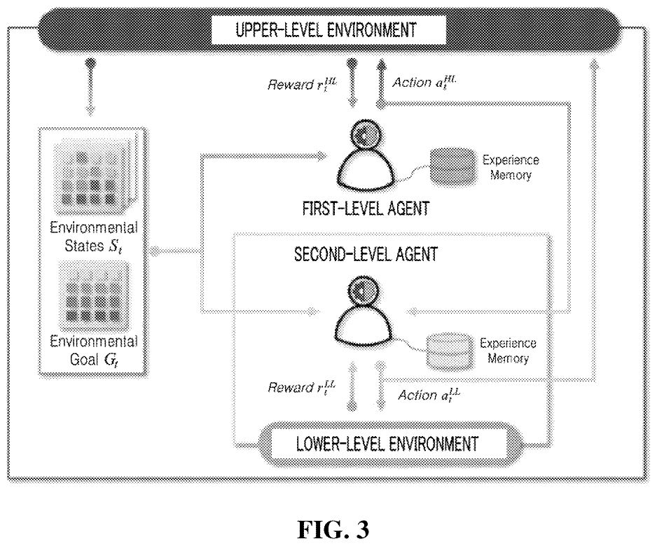

FIG. 3 is a diagram illustrating a specific configuration of a reinforcement learning model according to an embodiment of the present invention.

First, for each communication round, a first-level agent trained in an upper-level environment determines an index coding action, and a second-level agent trained in a lower-level environment determines a beamformer design action.

The first-level agent determines, for each user terminal, whether to perform index coding and, when index coding is performed, which index coding scheme is to be applied, as the index coding action, and uses a discrete action space. The first-level agent receives, as a state (State, Sₜ) input of a reinforcement learning environment, channel state information of all user terminals, transmission power, and an indicator including information on user terminals for which transmission has not yet been completed. In this case, in addition to the environment state information (Sₜ), environment goal (Gₜ) information may also be delivered to the first-level agent. Based on the environment state information (Sₜ) and the environment goal information (Gₜ), the first-level agent determines an index coding action

$$( Action , {a}_{t}^{H L} ) .$$

The second-level agent receives, as inputs, not only the environment state information (Sₜ) and the environment goal information (Gₜ) received by the first-level agent, but also the index coding action

$$( {a}_{t}^{H L} )$$

a determined by the first-level agent, and based thereon, determines a beamformer design action

$$( Action , {a}_{t}^{LL} ) .$$

When the action of the second-level agent is determined by the hierarchical structure of the first-level agent and the second-level agent, a delay time is calculated based on Mathematical Expression 5 described above.

$$T \hat{=} {\sum }_{l = 1}^{K} {T}_{i} = {\sum }_{l = 1}^{K} {max}_{k ∈ {𝒟}_{t}} [ \frac{B / W}{log ( 1 + SIN {R}_{ik} ( {v}_{{ℐ}_{t}} ) )} ] . \qquad [ Mathematical Expression 5 ]$$

Based on this, a first reward

$$( Reward , {r}_{t}^{HL} )$$

of the first-level agent and a second reward

$$( Reward , {r}_{t}^{HL} )$$

of the second-level agent are each defined as a value obtained by multiplying the delay time by −1, and accordingly, state-action pairs for reducing the delay time are learned.

For each communication round, the first-level agent and the second-level agent hierarchically and cooperatively determine actions of the corresponding round, including index coding and beamformer design, and when the K-th round is completed, an episode is terminated.

Meanwhile, according to an embodiment, the first-level agent may learn discrete actions by using a conventionally known Dueling Deep Q-Learning Network algorithm, and the second-level agent may perform learning for continuous actions by using a Soft Actor-Critic (SAC) algorithm. However, the present invention is not limited thereto, and any reinforcement learning algorithm for discrete actions and continuous actions may be used for the respective agents in the hierarchical structure as described above.

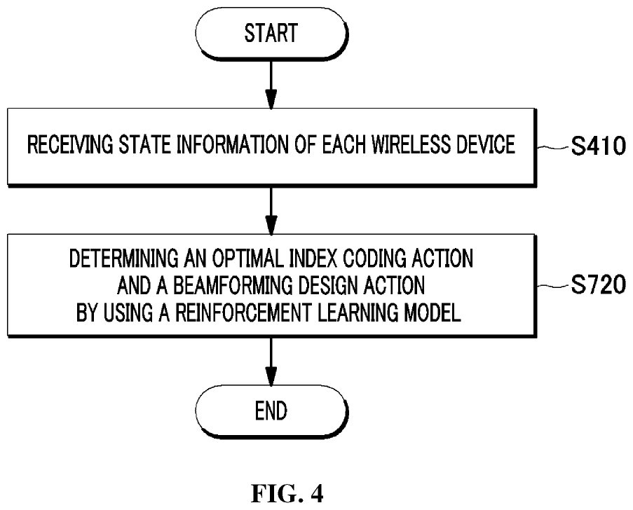

FIG. 4 is a flowchart illustrating a method for index coding and beamforming optimization between wireless devices of a computing apparatus according to an embodiment of the present invention.

First, the computing apparatus (100) receives state information of each wireless device (S410). In this case, the state information of each wireless device may include channel state information and information on transmission power.

Next, the computing apparatus (100) inputs the state information of each wireless device to a reinforcement learning model to determine an index coding action and a beamforming design action that minimize transmission time between the wireless devices (S420). In this case, as described above, the reinforcement learning model includes a hierarchical structure including a first-level agent and a second-level agent. The first-level agent determines, as the index coding action, whether each wireless device performs index coding and a type of an index coding scheme to be used for index coding. The second-level agent determines, as the beamforming design action, an optimal beamformer design for each wireless device in consideration of the index coding action determined by the first-level agent.

Meanwhile, although not illustrated in the drawings, the method may further include transmitting the determined index coding action and beamforming design action to each wireless device.

The method for index coding and beamforming optimization between wireless devices described above may also be implemented in the form of a recording medium storing computer-executable instructions such as program modules executed by a computer. The computer-readable medium may be any available medium that can be accessed by a computer, and includes both volatile and non-volatile media, and removable and non-removable media. In addition, the computer-readable medium may include a computer storage medium. The computer storage medium includes all types of volatile and non-volatile, removable and non-removable media implemented by any method or technology for storage of information such as computer-readable instructions, data structures, program modules, or other data.

Those skilled in the art to which the present invention pertains will understand that various modifications and variations may be made to the present invention without departing from the technical spirit or essential features thereof based on the above description. Accordingly, the embodiments described above should be understood as being illustrative in all respects and not restrictive. The scope of the present invention is defined by the appended claims, and all changes or modifications derived from the meaning and scope of the claims and their equivalents should be construed as being included in the scope of the present invention.

### DESCRIPTION OF REFERENCE NUMERALS

100: Computing apparatus
110: Communication module
120: Memory
130: Processor
140: Database
200: User terminal

What is claimed is:

1. A computing apparatus for performing index coding and beamforming optimization between wireless devices, comprising:
a memory in which an optimization program is stored; and
a processor configured to execute the optimization program,
wherein the optimization program inputs state information of the wireless devices to a reinforcement learning model to determine an index coding action and a beamforming design action that minimize transmission time between the wireless devices,
wherein the reinforcement learning model comprises:
a first-level agent configured to determine, as the index coding action, whether each wireless device performs index coding and a type of an index coding scheme to be used for index coding; and
a second-level agent configured to determine, as the beamforming design action, an optimal beamformer design for each wireless device in consideration of the index coding action determined by the first-level agent.

2. The computing apparatus of claim 1,
wherein the first-level agent determines the index coding action based on channel state information of the wireless devices, transmission power, and a first reward, and
wherein the second-level agent determines the beamforming design action based on the channel state information of the wireless devices, the transmission power, the index coding action determined by the first-level agent, and a second reward.

3. The computing apparatus of claim 2,
wherein the first reward and the second reward are each defined as a value obtained by multiplying a delay time by −1.

4. The computing apparatus of claim 1,
wherein the computing apparatus is configured to transmit the determined index coding action and the beamforming design action to each wireless device.

5. A method for performing index coding and beamforming optimization between wireless devices, performed by a computing apparatus, comprising:
receiving state information of each wireless device; and
inputting the state information of each wireless device to a reinforcement learning model to determine an index coding action and a beamforming design action that minimize transmission time between the wireless devices,
wherein the reinforcement learning model comprises:
a first-level agent configured to determine, as the index coding action, whether each wireless device performs index coding and a type of an index coding scheme to be used for index coding; and
a second-level agent configured to determine, as the beamforming design action, an optimal beamformer design for each wireless device in consideration of the index coding action determined by the first-level agent.

6. The method of claim 5,
wherein determining the index coding action and the beamforming design action comprises:
determining, by the first-level agent, the index coding action based on channel state information of the wireless devices, transmission power, and a first reward; and
determining, by the second-level agent, the beamforming design action based on the channel state information of the wireless devices, the transmission power, the index coding action determined by the first-level agent, and a second reward.

7. The method of claim 6,
wherein the first reward and the second reward are each defined as a value obtained by multiplying a delay time by −1.

8. The method of claim 5,
further comprising transmitting the determined index coding action and the beamforming design action to each wireless device.

9. A non-transitory computer-readable recording medium storing a computer program for performing the method for index coding and beamforming optimization between wireless devices according to claim 5.
